(19) United States
(12) Patent Application Publication
(10) Pub. No.: US 2018/0197099 A1
(43) Pub. Date: Jul. 12, 2018

(54) USER STATE PREDICTIONS FOR PRESENTING INFORMATION

(71) Applicant: Google Inc., Mountain View, CA (US)

(72) Inventors: Yuling Liang, Sunnyvale, CA (US); Carsten Steinebach, El Cerrito, CA (US); Wei Lwun Lu, Mountain View, CA (US); James Kunz, Los Altos, CA (US); Yew Jin Lim, Saratoga, CA (US)

(21) Appl. No.: 15/403,958

(22) Filed: Jan. 11, 2017

(51) Int. Cl. G06N 7/00; H04L 29/08; G06N 99/00

(52) U.S. Cl. CPC G06N 7/005; G06N 99/005; H04L 67/14; H04L 67/22

(57) ABSTRACT

A computing device is described that determines, based on a state of a user, an initial user-interaction metric for information to be presented to the user and predicts, using a machine-learning model, a plurality of future states of the user. Each future state is associated with a respective user-interaction metric for the information. The device determines whether the initial user-interaction metric for the information is greater than or equal to the respective user-interaction metric of each of the future states and outputs an indication of the information if the initial user-interaction metric is greater than or equal to the respective user-interaction metric of each of the future states. However, if the initial user-interaction metric for the information is less than the respective user-interaction metric of any of the future states, the device refrains from outputting the indication of the information.

### BACKGROUND

Some computing devices (e.g., a wearable device or a mobile phone) may be configured to notify users about news stories, product discounts, newly received messages, upcoming appointments, package deliveries, and other information that may be of interest to a user. For example, a computing device may have access to an internet browsing history of a user and the computing device may alert the user when a new article is posted that to a part of a website that the user previously visited. Or in another example, a computing device may have access to a shopping history of a user and the computing device may prompt the user with a newly available and/or discounted product or service that would complement a product purchased by the user in the past. Nevertheless, even though a user may sometimes find notifications to such information useful, outputting an indication of information that is ultimately ignored, or fails to gain a user's attention, may unnecessarily waste a computing device's battery power or tie up processing resources that could have been used to perform other tasks.

### SUMMARY

In general, techniques of this disclosure may enable a system or device to determine, from among several possible states of a user, a particular user state during which to output information, so that the output is more likely to garner positive attention from the user. In this way, the output may enable the system to avoid wasting energy and/or computing resources generating the output during a user state in which the output would likely be disliked, dismissed, or even ignored.

After receiving explicit consent to make use of and/or analyze information about a user of a computing device, an example system may utilize a machine-learning model (e.g., a deep-learning model or any other type of machine-learning model) to determine a current state of the user. The state may specify any number of physical and/or virtual characteristics of the user or the computing device, including any physical and/or virtual actions being performed by the user, so as to generally indicate what the user may be doing. The machine-learning model may determine, for the current state, one or more user-interaction metrics for information (e.g., a notification, a voice notification, a prompt, an alert, a banner, a message, an image, or any other visual, audible, or haptic type information) that is to be presented to the user. The user-interaction metrics may quantify a predicted interest level that the user, while in the current state, may have with respect to the information. For example, the information may be a breaking news headline from a news application executing at the computing device and the user-interaction metric associated with the news headline may be a click-through-rate, probability of the user liking, probability of the user dismissing, etc. the news headline if the news headline were to be presented to the user, while the user is in the current state.

The example system may also predict a plurality of future states (e.g., future contexts) of the user and for each of the plurality of future states, use the model to determine respective user-interaction metrics for the information if the information were to be presented while the user is in each of the future states. The respective user-interaction metrics for the information for each of the plurality of future states may be adjusted, by the machine-learning model, by a weighting factor for that particular future state. In other words, since each future state may have its own degree of likelihood of occurring (i.e., some future states may be more likely to occur than others), the machine-learning model may adjust the respective user-interaction metric for a future state by the future state's likelihood of occurrence.

If the user-interaction metric for the current state is greater than or equal to the respective user-interaction metric of each of the plurality of future states, the example system may prompt the user to the information by outputting an indication (e.g., audible, visual, or haptic prompt) of the information. However, if the example system deems the user-interaction metric for current state to be less than any of the respective user-interaction metrics of any of the plurality of future states, the example system may refrain from outputting the indication of the information (e.g., until a subsequent state of the user corresponds to the particular future state that has the highest user-interaction metric for the information). In other words, once the system receives clear and unambiguous permission from a user to make use of personal information about the user that is indicative of a current and future state of the user, the system may defer output of an indication of information until the system predicts the user is in a state in which he or she is most likely to positively interact with the information and not simply dismiss, dislike, or ignore the information. In this way, the techniques may enable the system to avoid wasting energy and/or resources, like some other computing devices do, by generating outputs to information that get disliked, dismissed, or ignored by the user.

In one example, the disclosure is directed to a method that includes determining, based on an initial state of a user of a computing device, an initial user-interaction metric for information to be presented to the user, predicting, using a machine-learning model, a plurality of future states of the user of the computing device, wherein each future state from the plurality of future states is associated with a respective user-interaction metric for the information that has been adjusted, by the machine-learning model, by a weighting factor for that particular future state, and determining whether the initial user-interaction metric for the information is greater than or equal to the respective user-interaction metric of each of the plurality of future states. The method further includes outputting an indication of the information if the initial user-interaction metric is greater than or equal to the respective user-interaction metric of each of the plurality of future states, and if the initial user-interaction metric for the information is less than the respective user-interaction metric of any of the plurality of future states, refraining from outputting the indication of the information.

In another example, the disclosure is directed to a computing device that includes at least one processor and a memory. The memory includes instructions that, when executed, cause the at least one processor to: determine, based on an initial state of a user of the computing device, an initial user-interaction metric for information to be presented to the user, and predict, using a machine-learning model, a plurality of future states of the user of the computing device, wherein each future state from the plurality of future states is associated with a respective user-interaction metric for the information that has been adjusted, by the machine-learning model, by a weighting factor for that particular future state. The memory further includes instructions that when executed, cause the at least one processor to determine whether the initial user-interaction metric for the information is greater than or equal to the respective user-interaction metric of each of the plurality of future states, output an indication of the information if the initial user-interaction metric is greater than the respective user-interaction metric of each of the plurality of future states, and if the initial user-interaction metric for the information is less than the respective user-interaction metric of any of the plurality of future states, refrain from outputting the indication of the information.

In another example, the disclosure is directed to a computer-readable storage medium including instructions that, when executed, cause at least one processor of a computing system to determine, based on an initial state of a user of a computing device, an initial user-interaction metric for information to be presented to the user and predict, using a machine-learning model, a plurality of future states of the user of the computing device, wherein each future state from the plurality of future states is associated with a respective user-interaction metric for the information that has been adjusted, by the machine-learning model, by a weighting factor for that particular future state. The instructions, when executed, further cause the at least one processor to determine whether the initial user-interaction metric for the information is greater than or equal to the respective user-interaction metric of each of the plurality of future states, output an indication of the information if the initial user-interaction metric is greater than or equal to the respective user-interaction metric of each of the plurality of future states, and if the initial user-interaction metric for the information is less than the respective user-interaction metric of any of the plurality of future states, refrain from outputting the indication of the information.

In another example, the disclosure is directed to a system that includes means for determining, based on an initial state of a user of a computing device, an initial user-interaction metric for information to be presented to the user, means for predicting a plurality of future states of the user of the computing device, wherein each future state from the plurality of future states is associated with a respective user-interaction metric for the information that has been adjusted, by the machine-learning model, by a weighting factor for that particular future state, and means for determining whether the initial user-interaction metric for the information is greater than or equal to the respective user-interaction metric of each of the plurality of future states. The system further includes means for outputting an indication of the information if the initial user-interaction metric is greater than the respective user-interaction metric of each of the plurality of future states, and if the initial user-interaction metric for the information is less than the respective user-interaction metric of any of the plurality of future states, means for refraining from outputting the indication of the information.

In another example, the disclosure is directed to a method that includes receiving, by a computing device, a notification indicating information that is to be presented to a user of the computing device; determining, using a machine-learning model, based on user information and other information about other users of other computing devices, an initial state of the user and a future state of the user; determining, using the machine-learning model, an initial user-interaction metric for presenting the information indicated by the notification during the initial state of the user and a future user-interaction metric for presenting the information indicated by the notification during the future state of the user, the future user-interaction metric having been adjusted, by the machine-learning model, by a weighting factor for the future state; if the initial user-interaction metric is greater than or equal to the future user-interaction metric, outputting, at a current time, an indication of the notification; and if the initial user-interaction metric is less than the future user-interaction metric, refraining from outputting the indication of the notification until a later time during which a subsequent state of the user corresponds to the future state.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example system for predicting when to output information to improve one or more user-interaction metrics for the information, in accordance with one or more aspects of the present disclosure.

FIG. 2 is a block diagram illustrating an example computing device configured to predict when to output information to improve one or more user-interaction metrics for the information, in accordance with one or more aspects of the present disclosure.

FIG. 3 is a conceptual diagram illustrating various user states during which an example computing device receives information and outputs indications of the information to improve one or more user-interaction metrics for the information, in accordance with one or more aspects of the present disclosure.

FIG. 4 is a flowchart illustrating example operations performed by an example computing device configured to predict when to output information to improve one or more user-interaction metrics for the information, in accordance with one or more aspects of the present disclosure.

FIG. 5 is a flowchart illustrating additional example operations performed by an example computing device configured to predict when to output information to improve one or more user-interaction metrics for the information, in accordance with one or more aspects of the present disclosure.

### DETAILED DESCRIPTION

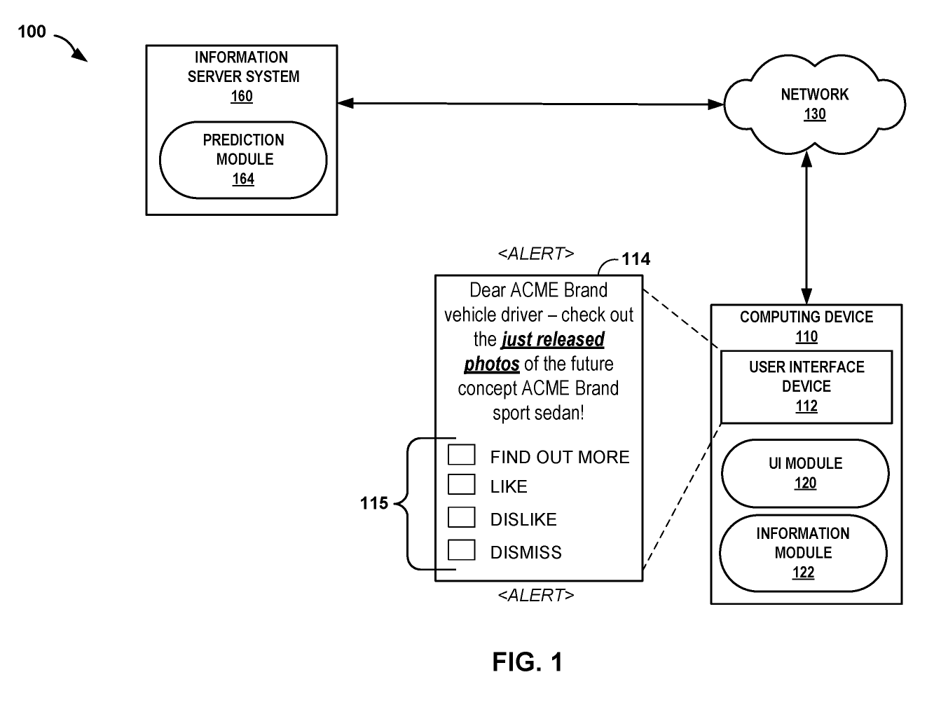

FIG. 1 is a conceptual diagram illustrating an example system for predicting when to output information to improve one or more user-interaction metrics for the information, in accordance with one or more aspects of the present disclosure. System 100 includes information server system (“ISS”) 160 in communication with computing device 110 via network 130. ISS 160 may determine current and future states of a user of computing device 110 and predict, based on the current and future states of the user, when computing device 110 should prompt the user with information. As will become apparent below, ISS 160 may use a machine-learning model for predicting current and future states of the user as well as user-interaction metrics for information that is to be presented to a user of computing device 110, for each of the predicted states. ISS 160 may determine that the particular state which has a highest respective user-interaction metric for information to be presented to a user is the state during which computing device 110 should prompt the user with the information.

As used herein, a “state of a user” or “user state” specifies any number of physical and/or virtual characteristics of a user of a computing device, or the computing device itself, including any physical and/or virtual actions performed by the user, so as to generally indicate what the user may be doing across a variety of dimensions (e.g., time, space, etc.). User states may define things such as location, time, action taken, application being used, activity being performed, and other characteristics of the user and/or device.

As used herein a “user-interaction metric” indicates a quantifiable measurement of user satisfaction, or improvement in user satisfaction, with regards to the presentation of information to the user, between two or more user states. That is, a user-interaction metric may indicate a quantifiable amount of user interest with respect to information if the information is presented in one particular user state as opposed to a different particular user state. Examples of user-interaction metrics include click-through-rate, probability of liking the information, probability of dismissing the information, probability of ignoring the information, user perceived level of usefulness the information, amount of time interacting with the information, or some other metric.

Network 130 represents any public or private communications network, for instance, cellular, Wi-Fi, and/or other types of networks, for transmitting data between computing systems, servers, and computing devices. Network 130 may include one or more network hubs, network switches, network routers, or any other network equipment, that are operatively inter-coupled thereby providing for the exchange of information between ISS 160 and computing device 110. Computing device 110 and ISS 160 may transmit and receive data across network 130 using any suitable communication techniques.

ISS 160 and computing device 110 may each be operatively coupled to network 130 using respective network links. The links coupling computing device 110 and ISS 160 to network 130 may be Ethernet, ATM or other types of network connections, and such connections may be wireless and/or wired connections.

Computing device 110 represents an individual mobile or non-mobile computing device. Examples of computing device 110 include a mobile phone, a tablet computer, a laptop computer, a desktop computer, a server, a mainframe, a set-top box, a television, a wearable device (e.g., a computerized watch, computerized eyewear, computerized gloves, etc.), or any other type of portable computing device, a personal digital assistants (PDA), portable gaming systems, media players, e-book readers, mobile television platforms, automobile navigation systems, automobile and/or home entertainment and infotainment systems, counter-top or mobile assistant devices (e.g., an “always listening” home assistant devices), or any other types of mobile, non-mobile, wearable, and non-wearable computing devices configured to receive information via a network, such as network 130.

Computing device 110 includes user interface device (UID) 112, user interface (UI) module 120, and information module 122. Modules 120-122 may perform operations described using software, hardware, firmware, or a mixture of hardware, software, and firmware residing in and/or executing at respective computing device 110. Computing device 110 may execute modules 120-122 with multiple processors or multiple devices. Computing device 110 may execute modules 120-122 as virtual machines executing on underlying hardware. Modules 120-122 may execute as one or more services of an operating system or computing platform. Modules 120-122 may execute as one or more executable programs at an application layer of a computing platform.

UID 112 of computing device 110 may function as an input and/or output device for computing device 110 and may be implemented using various technologies that enables computing device 110 to provide a user interface. For instance, UID 112 may function as an input device using microphone technologies, infrared sensor technologies, presence-sensitive input screens, touchscreens, pressure sensitive screens, or other input device technology for use in receiving user input. UID 112 may function as output (e.g., display) device using any one or more display devices, speaker technologies, haptic feedback technologies, or other output device technology for use in outputting information to a user. In the example of FIG. 1, UID 112 may display user interface 114, including indications (e.g., prompts, alerts, notifications, etc.) of information being output to the user by information module 122 or other modules, components, applications, and/or services executing at or accessible from computing device 110.

UI module 120 may manage user interactions with UID 112 and other input and output components of computing device 110 as the interactions relate to the user interface(s) provided by computing devices 110, including user interface 114. For example, UI module 120 may send commands and/or instructions to UID 112 that cause UID 112 to output user interface 114 for display. UI module 120 may receive one or more indications of input (e.g., touch data, voice data, etc.) detected by UID 112 as a user interacts with user interface 114. UI module 120 may send updated instructions and commands to UID 112 in response to the indications of input that cause UID 112 to modify the presentation of user interface 114. UI module 120 may interpret the indications of input detected by UID 112 and relay information about the inputs to other components of computing device 110 (e.g., module 122, other modules of computing device 110, applications executing at computing device 110, and/or services executing at, or accessible to, computing device 110). UI module 120 may send updated instructions and commands to UID 112 based on other information UI module 120 receives from the other components, to cause UID 112 to further modify the presentation of user interface 114.

In the example of FIG. 1, user interface 114 is illustrated as being a graphical (e.g., image or text based) and/or non-graphical (e.g., audible) user interface associated with an information service provided by information module 122. In other words, user interface 114 may output (graphical, haptic, or audible) prompts, alerts, or other types of notifications via UID 112 that alert a user of computing device 110 to information that information module 122 has determined may interest the user. As shown in FIG. 1, user interface 114 presents an indication (e.g., graphical or audible) of the information from information module 122 about just released photos of a new concept vehicle developed by ACME Brand automobiles. The indication of information may include a card-based graphical element, an icon, some other type of graphical element, audio, video, a voice-notification, or any other type of alert or prompt. In the case of a graphical user interface, user interface 114 may include selectable elements 115 at which a user can provide inputs to interact with the indication. In the case of a non-graphical user interface, user interface 114 may process voice or other types of inputs from that allow the user to interact with the indication.

In general, information module 122 collects and outputs information that is to be presented to a user of computing device 110. Information module 122 may be any type of information source that is executing at or accessible from computing device 110. Examples of information sources include various plugins, applications (i.e., “apps”), application extensions (i.e., “app extensions”), and the like, executing at computing device 110. Such information sources may come pre-loaded with computing device 110, be a built-in component of an operating platform or operating system, or may be third-party information services (e.g., downloaded and installed from a digital content distribution system). Examples of information module 122 include plugins, applications (also commonly referred to as “apps”), and app extensions for playing games, accessing search services, accessing online merchants or shopping services, accessing social media services, performing keyboard operations, accessing messaging services, or accessing services or performing functionality of any other plugin, app, or app extension executing at, or accessible from, computing device 110.

The types of information that information module 122 collects and outputs includes any human understandable information that could come from any of the above described types of information sources. Examples of the information collected and output from information module 122 includes content of e-mail or other messages, calendar appointments, reminders, alarms, notifications from news, gaming, or other types of applications, social media messages or posts, shopping or package delivery notifications, medical/fitness/physiological notifications, etc.

Information module 122 may rely on a prediction service provided by ISS 160 to determine precisely when to request UI module 120 to output a particular piece of information at UID 112 as part of user interface 114. For example, information module 122 may obtain information that is to be presented to the user and package the information as an indication of the information (e.g., as a card-based graphical element, an icon, text, some other type of graphical element, audio, video, a voice-notification, or any other type of form). Information module 122 may hold, buffer, or otherwise refrain from outputting the indication of the information to UI module 120 until instructed by the prediction service to do so. That is, information module 122 may defer output of the indication of information until the prediction service determines that the user of computing device 110 is more likely to positively receive the information.

ISS 160 represents any suitable remote computing system, such as one or more desktop computers, laptop computers, mainframes, servers, cloud computing systems, etc. capable of sending and receiving information both to and from a network, such as network 130. ISS 160 hosts (or at least provides access to) a service for predicting a particular user state during which to present information to a user so that the output maximizes one or more user-interaction metrics associated with the information. In some examples, ISS 160 represents a cloud computing system that is accessible via network 130. For example, computing device 110 (e.g., UI module 120 and/or information module 122) may communicate with ISS 160 via network 130 to access the prediction service provided by ISS 160.

In the example of FIG. 1, ISS 160 includes prediction module 164 which executes a machine-learning model that is configured to predict, for different user states, user-interaction metrics for information that is to be output to a user of a computing device. By predicting current or future states of a user, prediction module 164 can determine which of the current or future states to output information to the user so that the output of the information (e.g., a notification, a prompt, etc.) will perform better and garner the most positive attention from the user and therefore achieve higher user-interaction metrics.

Module 164 may perform operations described using software, hardware, firmware, or a mixture of hardware, software, and firmware residing in and/or executing at ISS 160. ISS 160 may execute module 164 with multiple processors or multiple devices. ISS 160 may execute module 164 as a virtual machine executing on underlying hardware. Module 164 may execute as one or more services of an operating system or computing platform. Module 164 may execute as one or more executable programs at an application layer of a computing platform.

Prediction module 164 may receive information from a computing device and in response, send a prediction as to when the computing device should output an indication of the information. For example, prediction module 164 may receive, via network 130 from information module 122, an indication of the ACME Brand vehicle announcement shown in user interface 114 of FIG. 1. Prediction module 164 may analyze the announcement and in view of the content of the announcement, the type of the announcement, the sender of the announcement, or some other attribute or characteristic of the announcement, as well as in view of information prediction module 164 has about computing device 110 and the user of computing device 110, output an indication of when (e.g., what time, what location, etc.) an indication of the announcement should be output to the user to maximize one or more user-interaction metrics associated with the announcement.

For example, prediction module 164 may have learned what type of performance (e.g., click-through-rate, dismissal rate, ignore rate, dislike rate, etc.) that this announcement or other similar announcements have had for the user of computing device 110 or other users of other computing devices, during a wide variety of user states. Based on the past knowledge attained, prediction module 164 may determine when this particular announcement should be output to give the output the best chance of being received by the user of the computing device.

Prediction module 164 may rely on contextual information about computing device 110, other computing devices, and users of computing device 110 and other computing devices to learn and predicts current and future states of users of computing devices as well as user-interaction metrics associated with information during those states. As used throughout the disclosure, the term “contextual information” is used to describe information that can be used by a computing system and/or computing device, such as information server system 160 and computing device 110, to define one or more physical and/or virtual, environmental characteristics associated with computing devices and/or users of computing devices in addition to one or more observable physical or virtual actions being taken by users of computing devices at a particular time. In other words, contextual information represents any data that can be used by a computing device and/or computing system to determine a “user context” indicative of the circumstances that form the virtual and/or physical experience the user is undergoing for a particular location at a particular time.

Examples of contextual information include past, current, and future physical locations, degrees of movement, magnitudes of change associated with movement, weather conditions, traffic conditions, patterns of travel, patterns of movement, application usage, calendar information, purchase histories, Internet browsing histories, and the like. In some examples, contextual information may include sensor information obtained by one or more sensors (e.g., gyroscopes, accelerometers, proximity sensors) of computing devices, such as computing device 110, radio transmission information obtained from one or more communication units and/or radios (e.g., global positioning system (GPS), cellular, Wi-Fi) of computing devices, information obtained by one or more input devices (e.g., cameras, microphones, keyboards, touchpads, mice) of computing devices, and network/device identifier information (e.g., a network name, a device internet protocol address). In some examples, contextual information may include communication information such as information derived from e-mail messages, text messages, voice mail messages or voice conversations, calendar entries, task lists, social media network related information, and any other information about a user or computing device that can support a determination of a user context.

Prediction module 164 may only make use of such contextual information after receiving an indication of affirmative and explicit consent from the user of computing device 110 to make use and store such information. Prediction module 164 can predict, based on contextual information about a current context of a user or a computing device, the current state of the user for the current context (e.g., what the user is doing for the current context). Prediction module 164 can also predict, based on contextual information about a historical context of the user or the computing device, the future state of the user for a future context (e.g., what the user will be doing for the future context).

In accordance with techniques of this disclosure, when prediction module 164 receives a request to analyze information that is to be output to a user (such as the announcement described above), prediction module 164 may determine, based on an initial state of a user of computing device 110, an initial user-interaction metric for information to be presented to the user and may further determine a plurality of future states of the user of computing device 110 where for each future state, prediction module 164 may also determine a respective user-interaction metric for the information. For example, prediction module 164 may receive a request from information module 122 to analyze and provide an indication as to when information module 122 should cause UI module 120 to output user interface 114 at UID 112. In response to the request, the machine-learning model of prediction module 164 may predict performance of the information (e.g., the announcement) across multiple user states or dimensions, such as time and location, and then score the information across a distribution of these multiple current and possible future states. Besides the information that is being analyzed for performance across various states, the machine-learning model may receive as input historical and current contextual information associated with computing device 110 or the user of computing device 110 and predict various user-interaction metrics (e.g., click-through rate, usefulness probability, probability of dismissal, etc.) for various current and future predicted states.

Prediction module 164 may adjust the respective user-interaction metrics for the information for each of the plurality of future states by a weighting factor for that particular future state. In other words, since each future state may have its own degree of likelihood of occurring (i.e., some future states may be more likely to occur than others), prediction module 164 may adjust the respective user-interaction metric for a future state by the future state's likelihood of occurrence. In other words, the respective user-interaction metrics for future states may be weighted by the respective likelihood of a corresponding future state. Some states might be very unlikely yet when they occur would yield high predicted interaction. To adjust for the unlikelihood of a particular future state (e.g., so the system doesn't wait around for too long waiting for a particularly unlikely future state to occur) the future user-interaction metric for the particularly unlikely future state may be adjusted accordingly.

If after adjusting the future user-interaction metrics according to their degree of likelihood, there is a large enough improvement in notification performance in a future state as compared to the current state, prediction module 164 may cause information module 122 to wait for that future state (e.g., 2 hours later, when the user leaves his or her work location, etc.) to cause UI module 120 and UID 112 to output the indication of the announcement. For example, prediction module 164 may determine whether the initial user-interaction metric for the information is greater than or equal to the respective user-interaction metric of each of the plurality of future states. If prediction module 164 determines that the initial user-interaction metric is greater than or equal to the respective user-interaction metric of each of the plurality of future states, prediction module 164 may send an instruction via network 130 to information module 122 to output the indication of the announcement immediately and not wait for a future state. Alternatively, if prediction module 164 determines that the initial user-interaction metric for the information is less than the respective user-interaction metric of each of the plurality of future states, prediction module 164 may send an instruction via network 130 to information module 122 to refrain from outputting the indication of the announcement until a subsequent state of the user corresponds to a particular future state during which the user-interaction metric is greater than or equal to the respective user-interaction metric of each other future state from the plurality of future states.

In this way, prediction module 164 may cause computing device 110 to defer output of an indication of information until the prediction module 164 predicts the user is in a state in which he or she is most likely to positively interact with the information and not simply dismiss, dislike, or ignore the information. Therefore, the techniques may enable a system such as system 100 to avoid wasting energy and/or resources, like some other computing devices do, by generating outputs to information that get disliked, dismissed, or ignored by the user. A further advantage beyond the energy and resource savings is that such a system may be perceived by a user as generating a higher quality user experience and therefore not appear to over-trigger or over-notify users, since too many notifications or notifications at the wrong time or in the wrong instance, may result in the unwanted effect of causing users to aggressively turn off such notifications due to high annoyance.

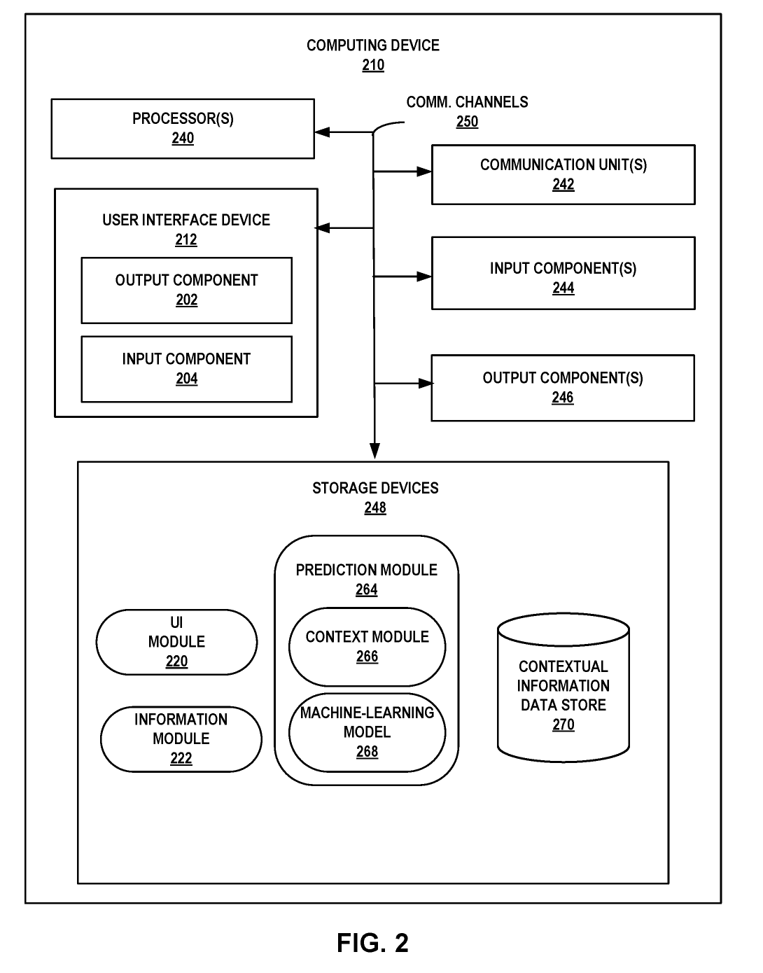

FIG. 2 is a block diagram illustrating an example computing device configured to predict when to output information to improve one or more user-interaction metrics for the information, in accordance with one or more aspects of the present disclosure. Computing device 210 of FIG. 2 is described below as an example of computing device 110 of FIG. 1 and further includes some or all the functionality of ISS 160 of FIG. 1. FIG. 2 illustrates only one example of computing device 210, and many other examples of computing device 210 may be used in other instances. Computing device 210 may include a subset of the components included in FIG. 2 or may include additional components not shown in FIG. 2.

As shown in the example of FIG. 2, computing device 210 includes user interface device (UID) 212, one or more processors 240, one or more communication units 242, one or more input components 244, one or more output components 246, and one or more storage components 248. UID 212 includes output component 202 and input component 204. Storage components 248 of computing device 210 include UI module 220, information module 222, and prediction module 264. Prediction module 264 includes context module 266 and machine-learning model 268 (e.g., a deep-learning model, a long-or-short term memory models, Bayesian networks, artificial neural networks, or any other machine learned models). Storage components 248 also includes contextual information data store 270.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on the one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 242 of computing device 210, in one example, includes a presence-sensitive input device (e.g., a touch sensitive screen, a PSD), mouse, keyboard, voice responsive system, video camera, microphone or any other type of device for detecting input from a human or machine. In some examples, input components 242 may include one or more sensor components one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., microphone, camera, infrared proximity sensor, hygrometer, and the like). Other sensors may include a heart rate sensor, magnetometer, glucose sensor, hygrometer sensor, olfactory sensor, compass sensor, step counter sensor, to name a few other non-limiting examples.

One or more output components 246 of computing device 110 may generate output. Examples of output are tactile, audio, and video output. Output components 246 of computing device 210, in one example, includes a PSD, sound card, video graphics adapter card, speaker, cathode ray tube (CRT) monitor, liquid crystal display (LCD), or any other type of device for generating output to a human or machine.

UID 212 of computing device 210 may be similar to UID 112 of computing device 110 and includes output component 202 and input component 204. Output component 202 may be a display component, such as a screen at which information is displayed by UID 212 and input component 204 may be a presence-sensitive input component that detects an object at and/or near display component 202. Output component 202 and input component 204 may be a speaker and microphone pair or any other combination of one or more input and output components, such as input components 244 and output components 244. In the example of FIG. 2, UID 212 may present a user interface (such as user interface 114 of FIG. 1).

While illustrated as an internal component of computing device 210, UID 212 may also represent an external component that shares a data path with computing device 210 for transmitting and/or receiving input and output. For instance, in one example, UID 212 represents a built-in component of computing device 210 located within and physically connected to the external packaging of computing device 210 (e.g., a screen on a mobile phone). In another example, UID 212 represents an external component of computing device 210 located outside and physically separated from the packaging or housing of computing device 210 (e.g., a monitor, a projector, etc. that shares a wired and/or wireless data path with computing device 210).

One or more processors 240 may implement functionality and/or execute instructions associated with computing device 210. Examples of processors 240 include application processors, display controllers, auxiliary processors, one or more sensor hubs, and any other hardware configure to function as a processor, a processing unit, or a processing device. Modules 220, 222, 264, and 266 and model 268 may be operable by processors 240 to perform various actions, operations, or functions of computing device 210. For example, processors 240 of computing device 210 may retrieve and execute instructions stored by storage components 248 that cause processors 240 to perform the operations modules 220, 222, 264, and 266 and model 268. The instructions, when executed by processors 240, may cause computing device 210 to store information within storage components 248.

One or more storage components 248 within computing device 210 may store information for processing during operation of computing device 210 (e.g., computing device 210 may store data accessed by modules 220, 222, 264, and 266, model 268, and data store 270 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220, 222, 264, and 266, model 268, and data store 270. Storage components 248 may include a memory configured to store data or other information associated with modules 220, 222, 264, and 266, model 268, and data store 270.

UI module 220 may include all functionality of UI module 120 of computing device 110 of FIG. 1 and may perform similar operations as UI module 120 for managing a user interface (e.g., user interface 114) that computing device 210 provides at presence-sensitive display 212 for providing output to, and handling input from, a user. For example, UI module 220 may receive information from UID 212 as UID 212 detects user input at input component 204 and may relay the input information to information module 222 and/or prediction module 264 for further processing. In response to receiving information from modules 222 and/or 264, UI module 220 may cause UID 212 to output information via output component 202 (e.g., as part of user interface 114).

Information module 222 may include all functionality of information module 122 of computing device 110 of FIG. 1 and may perform similar operations as information module 122 for providing indications of information to UI module 220 for inclusion in a user interface at UID 212. That is, information module 222 may collect and output information that is to be presented via UID 212 to a user of computing device 210. Information module 222 may be any type of information source that is executing at or accessible from computing device 220.

Similar to prediction module 164 of ISS 160, prediction module 264 is configured to predict a particular user state during which to present information to a user so that the output of the information maximizes one or more user-interaction metrics associated with the information. Prediction module 164 includes context module 266 and machine-learning model 268.

Context module 266 may process and analyze contextual information associated with computing device 210 to define a context of computing device 210 or a context of a user of computing device 210. The context of computing device 210 may specify one or more characteristics associated with computing device 210 and/or the user of computing device 210 and his or her physical and/or virtual environment at various locations and times. For example, context module 266 may determine, as part of a context of computing device 210, a physical location associated with computing device 210 at a particular time based on the contextual information associated with computing device 210 from that particular time. As the contextual information changes (e.g., based on sensor information indicative of movement over time), context module 266 may update the physical location in the determined context of computing device 210.

The types of information that define a context of a computing device for a particular location and/or time are too numerous to list. As some examples, a context of a computing device may specify: a location, a movement trajectory, a direction, a speed, a name of an establishment, a street address, a type of place, a building, weather conditions, and traffic conditions, at various locations and times. The context of the computing device may further include calendar information that defines a meeting or an event associated with various locations and times, webpage addresses viewed at various locations and times, text entries made in data fields of the webpages viewed at various locations and times (e.g., search or browsing histories), and other application usage data associated with various locations and times. The context of the computing device may further include information about audio and/or video streams accessed by the computing device at various locations and times, television or cable/satellite broadcasts accessed by the computing device at various locations and times, and information about other services accessed by the computing device at various locations and times.

After receiving explicit consent from a user to store and make use of personal information, Context module 266 may maintain past and future contextual histories associated with the user of computing device 210 at contextual information data store 270. Context module 266 may encrypt or otherwise treat the information being analyzed and/or stored at data store 270 to remove the actual identity of the user before storing or making use of the personal. For example, the information may be treated by context module 266 so that any personally-identifiable information is removed when stored or sent to a remote computing device for processing.

Context module 266 may catalog and record, at data store 270, previous contexts of computing device 210 at various locations and times in the past and from the previously recorded contexts, may project or infer future contexts of computing device 210 at various future locations and future times. Context module 266 may associate future days and future times with the recurring contexts of prior days and times to build a future contextual history associated with the user of computing device 210.

For example, the information contained in a past contextual history of computing device 210 may indicate the location of the user during the user's typical work week as the user travels along a typical route to and from a work location to a home location. Based on the past contextual history, context module 266 may produce a future contextual history that includes information indicating expected locations of the user during a future work week that mirror the actual locations recorded in the past contextual history.

Context module 266 may supplement a future contextual history associated with the user of computing device 210 with information stored on an electronic calendar or information mined from other communications information associated with computing device 210. For example, the electronic calendar may include a location associated with an event or appointment occurring at a future time or day when the user is typically at a home location. Rather than include the home location during the future time or day of the event as the expected location in the future contextual history, context module 266 may include event location as the expected location during the future time or day of the event.

Context module 266 may share the past, current, and future context stored at data store 270 with machine-learning model 268 from which machine-learning model 268 may predict, infer, or confirm a current or future state of a user of computing device 210. Context module 266 may respond to a request from machine-learning model 268 for a current context or current state associated with computing device 210 and or a future context or future state associated with computing device 210, by outputting data to machine-learning model 268 that specifies the current state and/or one or more future states of the user.

Machine-learning model 268 is configured to predict, for different user states, user-interaction metrics for information that is to be output to a user of computing device 210. Machine-learning model 268 may determine a current or future user state by relying on information from context module 266 and information stored at data store 270. By predicting current or future states of a user, machine-learning model 268 can determine during which of the current or future states to instruct information module 222 to output information to the user via UI module 220 and UID 212 so that the output of the information (e.g., a notification, a prompt, etc.) will perform better—that is, garner the most positive attention from the user and therefore achieve higher user-interaction metrics. Machine-learning model 268 may output, to prediction module 264, data indicative of whether a user-interaction metric of a current state for information that is to be output to a user is greater than or equal to respective user-interaction metrics of future states. Machine-learning model 268 may execute locally at computing device 210 or at a remote computing system (e.g., ISS 160) that is external to and communicatively coupled to computing device 210 via an external network.

In some examples, machine-learning model 268 may determine user-interaction metrics based on meta data or information about the information to be presented, in addition to, or independent of, the content of the information to be presented. In other words, machine-learning model 268 may at least one of a type of the information, a priority of the information, or content of the information when predicting a user-interaction metric, for a particular user state. For example, if information to be presented to a user has a short-time expiration or is from a particularly important sender, or has a flag indicating that it is of a particularly high priority piece of information, machine-learning model 268 may predict a greater user-interaction metric for the information in the current state, than if the information to be presented to the user has a greater-time expiration or is from a less important (e.g., commercial or third-party) sender, or has a flag indicating that it is of a low-priority piece of information.

In a similar way, machine-learning model 268 may analyze the content, sender, priority, and/or type of information to be presented, when determining user-interaction metrics for the information, for future states. For example, if information to be presented to a user has a long-time expiration or is from a less important sender, or has a flag indicating that it is of a low priority piece of information, machine-learning model 268 may predict a greater user-interaction metric for the information in one or more of the future states, as opposed to the current state, than if the information to be presented to the user has a shorter-time expiration or is from a more important (e.g., personal, work, family, friend, known) sender, or has a flag indicating that it is of a high-priority piece of information.

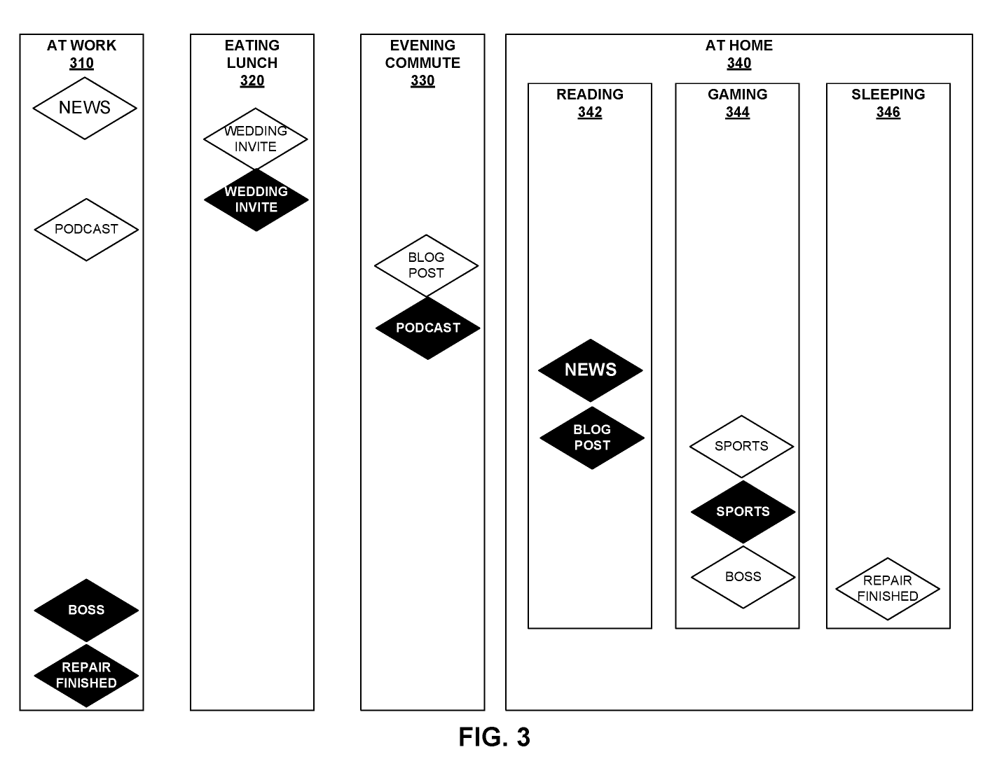

FIG. 3 is a conceptual diagram illustrating various user states during which an example computing device receives information and outputs indications of the information to improve one or more user-interaction metrics for the information, in accordance with one or more aspects of the present disclosure. FIG. 3 is described in the context of computing device 210 of FIG. 2.

FIG. 3 includes multiple rectangles, with each representing a specific user state 310-346. Machine-learning model 268 may determine that a user of computing device 210 is currently in any one of user states 310-346 based, for example, on information received from context module 262.

To illustrate during which of user states 310-346 that computing device 210 either receives information or outputs indications of information, each of user states 310-346 also includes one or more white and/or black diamond shapes. Each white colored diamond represents a new piece of information obtained by information module 222 that information module 222 determines should be presented to the user of computing device 210. Each black colored diamond represents an indication of information being output by UI module 220 and UID 212, for instance, as part of user interface 114. Textual labels are used to show the relationship between each white colored diamond and its corresponding black colored diamond.

In the example of FIG. 3, assume computing device 210 is a mobile phone and the user of computing device 210 begins his morning at work. While the user is at work, information module 222 of computing device 210 receives information about an interesting news headline that information module 222 determines should be presented to the user. To determine when to cause computing device 210 to output an indication of the news headline, information module 222 may query prediction module 264 for data indicating when to output the news headline. Until information module 222 receives a response to the query, information module 222 may refrain from causing UI module 220 and UID 212 to output any indication of the news headline. In other words, information module 222 may defer output of the indication of the news headline until instructed to do so.

Machine-learning model 268, in response to the request from information module 222, may query context module 264 for a context of the user. Machine-learning model 268 made determine that the current state of the user corresponds to user state 310 indicating that the user is working. Machine-learning model 268 may analyze the news headline to determine a user-interaction metric associated with an indication of the news article during user state 310. Machine-learning model 268 may also determine respective user-interaction metrics associated with the indication of the news article for user states 320-346, that is, a plurality of future states that the user may be in after being in user state 310. Machine-learning model 268 may determine that the user-interaction metric for the news article is not as high for user state 310 as the respective user-interaction metric for the news article during user state 340 when the user is at home and user state 342, i.e., particularly when the user is reading at home. Therefore, machine-learning model 268 may infer that the user will be more likely to appreciate and click-through a notification of the news headline if computing device 210 outputs the notification when the user is at home and reading and defer output until such time.

While the user is at lunch, information module 222 receives information about a wedding invitation sent via e-mail or social media post that information module 222 determines should be presented to the user. To determine when to cause computing device 210 to output an indication of the wedding invitation, information module 222 may again query prediction module 264 for data indicating when to output the wedding invite. Machine-learning model 268 made determine that the current state of the user when receiving the wedding invite corresponds to user state 320 indicating that the user is eating lunch. Machine-learning model 268 may analyze the wedding invite to determine a user-interaction metric associated with an indication of the wedding invite during user state 320. Machine-learning model 268 may also determine respective user-interaction metrics associated with the indication of the wedding invite for user states 310 and 330-346. Machine-learning model 268 may determine that the user-interaction metric for the wedding invite is greater than or equal to the user-interaction metric for all the other states 310 and 330-346 and therefore respond to information module 222 with a command to output the indication of the wedding invitation immediately (while the user is currently in user state 320). Information module 222 may send instructions to UI module 220 that causes UID 212 to present the indication of the wedding invite for the user to enjoy reading while he is at lunch.

After lunch, and back at work, information module 222 receives information about a new radio podcast that information module 222 determines should be presented to the user. To determine when to cause computing device 210 to output an indication of the new podcast, information module 222 may again query prediction module 264 for data indicating when to output the podcast alert. Machine-learning model 268 made determine that user state 330, when the user is commuting home, is the user state from states 310-346 that has the highest user-interaction metric associated with the podcast alert. Therefore, machine-learning model 268 may infer that the user will be more likely to appreciate a new podcast alert while driving home on his commute cause computing device 210 to defer output until such time.

During his commute, information module 222 receives information about a new blog post that information module 222 determines should be presented to the user. To determine when to cause computing device 210 to output an indication of the new podcast, information module 222 may again query prediction module 264 for data indicating when to output the bog post alert. Machine-learning model 268 made determine that user state 342, when the user is at home at reading, is the user state from states 310-346 that has the highest user-interaction metric associated with the bog post alert and may cause computing device 210 to defer output until such time. In addition, while the user is commuting, machine-learning model 268 may recognize that the user state is not user state 330 and send information to information module 222 letting information module 222 know that the current user state is when information module 222 should alert the user about the new podcast. Information module 222 may send instructions to UI module 220 that causes UID 212 to present the indication of the new podcast for the user to enjoy while commuting home from work.

Once at home, machine-learning model 268 may receive information from context module 266 and determine that the user state is user state 342 since the contextual information obtained by context module 266 indicates that the user is reading at his home location. Machine-learning model 268, upon recognizing the user is in a user state that is best suited for presenting an indication of the news headline and an indication of the blog post alert, may send a command to information module 222 that causes information module 222 to output indications, via UI module 220 and UID 212, of the news headline and the blog post.

Later on, while the user is playing a game at his home, information module 222 may receive information about a sports score update for a user's favorite sports team and may also receive information about a new e-mail from his boss. Information module 222 may query prediction module 264 for data indicating when to output an indication of the sports score and e-mail from the user's boss. Machine-learning model 268 may receive information from context module 266 and determine that the user state is user state 344 since the contextual information obtained by context module 266 indicates that the user is playing a game at his home location. Machine-learning model 268 may determine that the user-interaction metric for the sports score during state 344 is greater than or equal to the respective user-interaction metric for the sports score during any other state 310-346. Therefore, machine-learning model 268 may output data to information module 222 that causes modules 222 and 220 to output via UID 212, a prompt about the sports score. Unlike the sports score alert however, machine-learning model 268 may determine that the user-interaction metric for the boss' e-mail during state 344 is not greater than or equal to any respective user-interaction metric for the e-mail during any other state 310-346. Therefore, machine-learning model 268 may cause information module 222 to defer output of a prompt about the e-mail until a later time when the user is in a state that has a better or the best change of gaining the attention of and not annoying the user.

While the user of computing device 210 is sleeping, information module 222 receives a notification indicating that a repair to the user's laptop has been completed and ready for pick-up the next day during normal business hours. To determine when to cause computing device 210 to output an indication of the notification, information module 222 may again query prediction module 264 for data indicating when to output the repair notification. Machine-learning model 268 may determine that the current state of the user, i.e., user state 346, does not have a particularly high user-interaction metric associated with the repair notification relative to other user states and may therefore refrain from causing computing device 210 to output an indication of the repair notification while the user is sleeping.

The next day, the user returns to work. Upon recognizing that the user is in user state 310, deep learning model 268 reevaluates the user-interaction metrics for the boss's e-mail and the repair notification for user state 310 and determines that the current user state has the highest user-interaction metric for these two pieces of information. Deep learning model 268 may stop deferring the output of the indications related to these two pieces of information and may send data to information module 222 to cause the indications to be immediately output by computing device 210 via UI module 220 and UID 212.

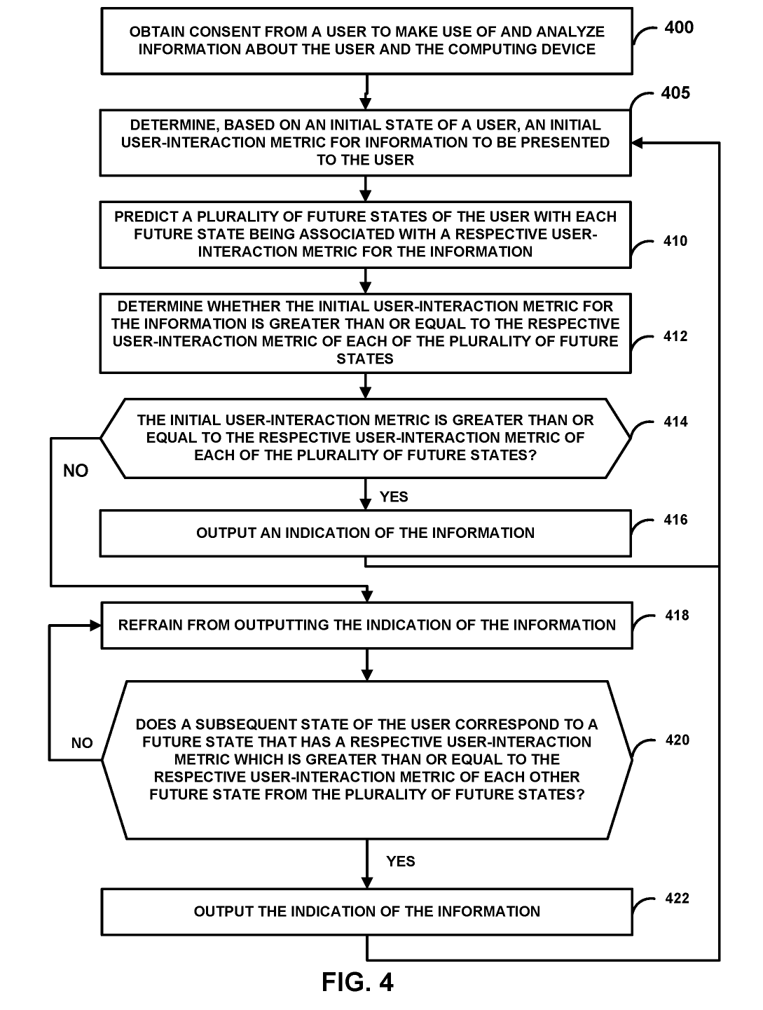

FIG. 4 is a flowchart illustrating example operations performed by an example computing device configured to predict when to output information to improve one or more user-interaction metrics for the information, in accordance with one or more aspects of the present disclosure. Operations 400-422 may be performed by a computing device, such as computing device 210, a computing system, such as ISS 160, or a combination of a computing device and computing system, such as system 100. For ease of description, FIG. 4 is described in the context of computing device 210 of FIG. 2.

As shown in FIG. 4, in operation, computing device 210 may obtain clear and unambiguous consent from the user to make use of and analyze information about the user and computing device 210 (400). For example, computing device 210 may cause UID 212 to present a prompt asking the user to affirmatively give permission for computing device 210 to evaluate information about the user, computing device 210, and information that computing device 210 receives that is to be presented to the user. The user may check a box in settings menu or affirmatively reply to the prompt to provide his or her consent. Computing device 210 may enable to the user to withdraw his or her consent at any time by unchecking the box or providing some other type of input to withdraw consent.

After obtaining clear and unambiguous consent from the user to make use of and analyze information about the user and computing device 210, computing device 210 may determine, based on an initial state of a user of computing device 210, an initial user-interaction metric for information to be presented to the user (405). For example, information module 222 may be a notification management component of computing device 210 that receives one or more pieces of notification data from applications and services executing at and accessible to computing device 210. While a user of computing device 210 is at work, information module 222 may receive notification data about a new e-mail message received at user's e-mail account. The new e-mail message may be a proportional e-mail for a tabloid magazine the user frequently reads. Information module 222 may send an indication of the notification data to prediction module 264 to determine when to output an indication of the new e-mail message.

Machine-learning model 268 of prediction module 264 may obtain contextual information (e.g., location data, calendar information, sensor data, etc.) from context module 266 about the user state and determine that the current state of the user is he or she is working or at work (e.g., in a meeting, at his or her desk, etc.). Machine-learning model 268 may determine that the type of notification data corresponds to low-priority information, and more specifically, low-priority information that the user may not be interested in unless he or she is reading at home. Therefore, machine-learning model 268 may assign a low user-interaction metric to the e-mail message, for the current state.

Computing device 210 may predict a plurality of future states of the user of the computing device, with each future state from the plurality of future states being associated with a respective user-interaction metric for the information (410). For instance, because machine-learning model 268 may determine that the type of notification data corresponds to low-priority information, and more specifically, low-priority information that the user may not be interested in unless he or she is reading at home, machine-learning model 268 may assign a high user-interaction metric to the e-mail message, for a future state of the user, specifically, a high user-interaction metric for a future state that corresponds to being at the user's home location and an even higher user-interaction metric for a future state that corresponds to the user reading at the home location.

Computing device 210 may determine whether the initial user-interaction metric for the information is greater than or equal to the respective user-interaction metric of each of the plurality of future states (412). For example, machine-learning model 268 may compare values of each of the user-interaction metrics for the current and future states to determine which of the current and future states has a highest user-interaction metric associated with the information.

If the initial user-interaction metric is greater than or equal to the respective user-interaction metric of each of the plurality of future states (414, YES path), computing device 210 may output an indication of the information (416) and return to step 405. For example, if machine-learning model 268 determines that the current state has the highest user-interaction metric for the new e-mail message, machine-learning model 268 will send a message to information module 222 letting the notification management client know that the current time and state is the best time to output an indication of the new e-mail message.

However, being that the user is currently working and would not likely care to read an article in the tabloid magazine while he or she is working, machine-learning model 268 may defer sending the message to information module 222 or at least send a message to information module 222 telling information module 222 to buffer the notification data and defer outputting an indication of the new e-mail message for now. In other words, if the initial user-interaction metric for the information is less than the respective user-interaction metric of each of the plurality of future states (414, NO path), computing device 210 may refrain from outputting the indication of the information (418).

After refraining from outputting the indication of the information, computing device 210 may determine whether a subsequent state of the user corresponds to a particular future state from the plurality of future states that has a respective user-interaction metric of the particular future state is greater than or equal to the respective user-interaction metric of each other future state from the plurality of future states (420). For example, at a subsequent time, the user may commute home and return to his or her home location. All during the day, while the user is working and during an after the commute home, machine-learning model 268 may periodically evaluate the current state of the user to determine whether the user state has changed and if so, whether the user-interaction metric for the new e-mail message for any of the different user states is at a level for triggering the output of an indication of the new e-mail message.

Responsive to determining that a subsequent state of the user corresponds to a particular future state from the plurality of future states that has a respective user-interaction metric of the particular future state is greater than or equal to the respective user-interaction metric of each other future state from the plurality of future states particular future state from the plurality of future states (420, YES path), computing device 210 may output the indication of the information (422) and return to step 405. Otherwise, after failing to determine a subsequent state of the user corresponds to a particular future state from the plurality of future states that has a respective user-interaction metric of the particular future state is greater than or equal to the respective user-interaction metric of each other future state from the plurality of future states particular future state from the plurality of future states (420, NO path), computing device 210 may continue to refrain from outputting the indication of the information (418). For example, when the user returns home, machine-learning model 268 may determine whether the user-interaction metric for the new e-mail while in the current state is greater than or equal to a predicted user-interaction metric for any possible future state. Machine-learning model 268 may determine that the user is likely to be reading later in the evening while at home, as he or she typically does on days he or she works, and determine that the predicted user-interaction metric for the future state of reading while at home exceeds the user-interaction metric for the current state, which is cooking, cleaning, or doing some other task while at home.

Machine-learning module may continue to cause computing device 210 to refrain from outputting an indication of the new e-mail. Later however, machine-learning model 268 may receive contextual information (e.g., application usage data indicating that the user just opened a web browser or reading application executing at computing device 210) from context module 266, and determine that the user is currently reading while at home. In response, machine-learning model 268 may send a message to information module 222 to alert the notification management client that now is a good time to cause UI module 220 and UID 212 to output an indication of the new e-mail message. In this way, by deferring output of an indication of the new e-mail message until a time and state in which the user is most likely to enjoy the indication, computing device 210 has improved the overall user experience associated with computing device 210 and has also avoided wasting consuming battery power by generating notifications to information that get dismissed, disliked, or ignored.

In some examples, computing device 210 may continue outputting one or more other indications of other information while refraining from outputting the indication of the information (418) and prior to determining that the subsequent state of the user corresponds to the particular future state (420, YES path). In other words, just because machine-learning model 268 of computing device 210 may command information module 222 to refrain from outputting an indication of one particular piece of information in the current state, machine-learning model 268 may instruct information module 222 to output one or more indications of other pieces of information, that have user-interaction metrics for the current state that exceed or are equal to user-interaction metrics for all other future states.

In some examples, instead of “refraining from outputting an indication of information” until a subsequent future, computing device 210 may output the indication of the information immediately (even if the initial user-interaction metric is less than a future user-interaction metric), with a user-selectable “wait until later” option tied to the indication. For example, computing device 210 may output a graphical indication of a news headline that includes with the text, a selectable element to “wait until later” the notification and cause computing device to resurface the notification at a later time, such as when computing device 210 determines that a user-interaction metric for the information is sufficiently high to warrant its output. This might be especially useful for “fresh” or “breaking” news or other important information that the user might appreciate knowing as soon as possible.

For example, computing device 210 may receive a notification for a new music album at 8 AM in the morning but the user may be busy and may not want to deal with the notification at that time. Computing device 210 may recognize that given the low value tied to the user-interaction metric for the notification in the user's current state, that now is not an optimal time to output such a notification. However, based on previous information about the user's interest in music and music related news, computing device 210 may, rather than wait until a future state in which the user-interaction metric is higher (e.g., instead of just waiting until 8 PM when the user is home) computing device 210 may still output the notification with an option “Later” or “Wait until later” or something with the options for outputting the notification at a later time, location, etc. Then, if the user selects the “Later” option, computing device 210 will defer a subsequent output of the notification until a future state in which the user-interaction metric for the information is high.

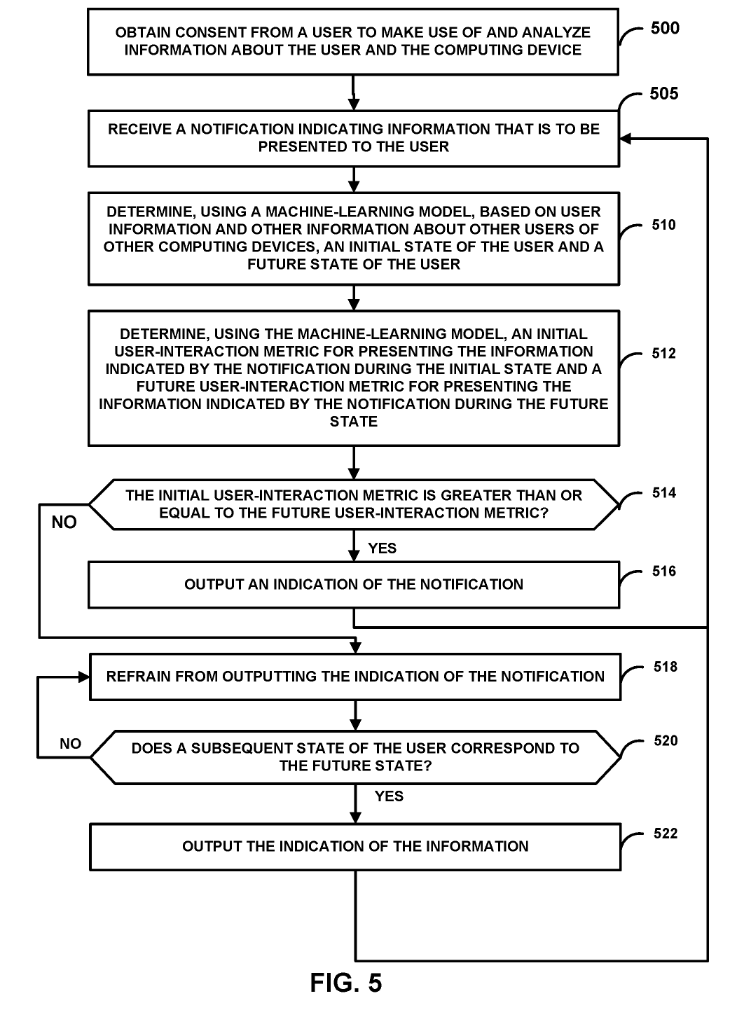

FIG. 5 is a flowchart illustrating example operations performed by an example computing device configured to predict when to output information to improve one or more user-interaction metrics for the information, in accordance with one or more aspects of the present disclosure. Operations 500-522 may be performed by a computing device, such as computing device 210, a computing system, such as ISS 160, or a combination of a computing device and computing system, such as system 100. For ease of description, FIG. 5 is described in the context of computing device 210 of FIG. 2.

As shown in FIG. 5, in operation, computing device 210 may obtain clear and unambiguous consent from the user to make use of and analyze information about the user and computing device 210 (500). For example, computing device 210 may cause UID 212 to present a prompt asking the user to affirmatively give permission for computing device 210 to evaluate information about the user, computing device 210, and information that computing device 210 receives that is to be presented to the user. The user may check a box in settings menu or affirmatively reply to the prompt to provide his or her consent. Computing device 210 may enable to the user to withdraw his or her consent at any time by unchecking the box or providing some other type of input to withdraw consent.

After obtaining clear and unambiguous consent from the user to make use of and analyze information about the user and computing device 210, computing device 210 may receive a notification indicating information that is to be presented to the user (505). For example, information module 222 may be a notification management component of computing device 210 that receives one or more pieces of notification data from applications and services executing at and accessible to computing device 210. While a user of computing device 210 is at work, information module 222 may receive notification data about a new e-mail message received at user's e-mail account. The new e-mail message may be a proportional e-mail for a tabloid magazine the user frequently reads. Information module 222 may send an indication of the notification data to prediction module 264 to determine when to output an indication of the new e-mail message.

Computing device 210 may determine, using a machine-learning model, based on user information and other information about other users of other computing devices, an initial state of the user and a future state of the user (510). For instance, machine-learning model 268 of prediction module 264 may obtain contextual information (e.g., location data, calendar information, sensor data, etc.) from context module 266 about the user state and determine that the current state of the user is he or she is commuting home from work (e.g., in a car, on a train, on a bus, etc. etc.). Additionally, machine-learning model 268 may determine that a future state of the user is that he or she will be at home reading (e.g., based on location history and application usage data indicating that in the evening on weekdays the user reads using computing device 210) at a future time.

Computing device 210 may determine, using the machine-learning model, an initial user interaction metric for presenting the information indicated by the notification during the initial state and a future user-interaction metric for presenting the information indicated by the notification during the future state (512). For example, machine-learning model 268 may determine that the type of notification received at step 505 corresponds to low-priority notification, and more specifically, low-priority information that the user may not be interested in reading while commuting, and only interested in if he or she is reading in the privacy of his or her home. Therefore, machine-learning model 268 may assign a low user-interaction metric to the e-mail message, for the current state. And because machine-learning model 268 may determine that the type of notification data corresponds to low-priority information, and more specifically, low-priority information that the user may not be interested reading in unless he or she is reading in the privacy of his or her home, machine-learning model 268 may assign a high user-interaction metric to the e-mail message, for the future state of the user that corresponds to the user reading at the home location.

Computing device 210 may determine whether the initial user-interaction is greater than or equal to the future user-interaction metric (512). For example, machine-learning model 268 may compare values of each of the user-interaction metrics for the current and future states to determine which of the current and future states has a highest user-interaction metric associated with the information.

If the initial user-interaction metric is greater than or equal to the respective user-interaction metric of each of the plurality of future states (514, YES path), computing device 210 may output an indication of the information (516) and return to step 505. For example, if machine-learning model 268 determines that the current state has the highest user-interaction metric for the new e-mail message, machine-learning model 268 will send a message to information module 222 letting the notification management client know that the current time and state is the best time to output an indication of the new e-mail message.

However, being that the user is currently commuting and would not likely care to read an article in the tabloid magazine while he or she is commuting, machine-learning model 268 may defer sending the message to information module 222 or at least send a message to information module 222 telling information module 222 to buffer the notification data and defer outputting an indication of the new e-mail message for now. In other words, if the initial user-interaction metric for the information is less than the respective user-interaction metric of each of the plurality of future states (514, NO path), computing device 210 may refrain from outputting the indication of the information (518).

After refraining from outputting the indication of the information, computing device 210 may determine whether a subsequent state of the user corresponds to the future state (520). For example, at a subsequent time, the user may arrive at home and. All during the user's commute, machine-learning model 268 may periodically evaluate the current state of the user to determine whether the user state has changed and if so, whether the user-interaction metric for the new e-mail message for any of the different user states is at a level for triggering the output of an indication of the new e-mail message.

Responsive to determining that a subsequent state of the user corresponds the future state that has a future user-interaction metric that is greater than the initial user-interaction metric (520, YES path), computing device 210 may output the indication of the notification (522) and return to step 505. Otherwise, after failing to determine a subsequent state of the user corresponds to the future state (520, NO path), computing device 210 may continue to refrain from outputting the indication of the notification (518). For example, when the user returns home, machine-learning model 268 may determine whether the user-interaction metric for the new e-mail while in the current state is greater than or equal to a predicted user-interaction metric for any possible future state. Machine-learning model 268 may determine that the user is likely to be reading later in the evening while at home, as he or she typically does on days he or she works, and determine that the predicted user-interaction metric for the future state of reading while at home exceeds the user-interaction metric for a new current state, which is cooking, cleaning, or doing some other task while at home.

Machine-learning module may continue to cause computing device 210 to refrain from outputting an indication of the new e-mail. Later however, machine-learning model 268 may receive contextual information (e.g., application usage data indicating that the user just opened a web browser or reading application executing at computing device 210) from context module 266, and determine that the user is currently reading while at home. In response, machine-learning model 268 may send a message to information module 222 to alert the notification management client that now is a good time to cause UI module 220 and UID 212 to output an indication of the new e-mail message. In this way, by deferring output of an indication of the new e-mail message until a time and state in which the user is most likely to enjoy the indication, computing device 210 has improved the overall user experience associated with computing device 210 and has also avoided wasting consuming battery power by generating notifications to information that get dismissed, disliked, or ignored.

In some examples, computing device 210 may continue outputting one or more other indications of other information while refraining from outputting the indication of the information (518) and prior to determining that the subsequent state of the user corresponds to the future state (520, YES path). In other words, just because machine-learning model 268 of computing device 210 may command information module 222 to refrain from outputting an indication of one notification in the current state, machine-learning model 268 may instruct information module 222 to output one or more indications of other notifications, that have user-interaction metrics for the current state that exceed or are equal to user-interaction metrics for all other future states.

Clause 1. A method comprising: determining, based on an initial state of a user of a computing device, an initial user-interaction metric for information to be presented to the user; predicting, using a machine-learning model, a plurality of future states of the user of the computing device, wherein each future state from the plurality of future states is associated with a respective user-interaction metric for the information; determining whether the initial user-interaction metric for the information is greater than or equal to the respective user-interaction metric of each of the plurality of future states; outputting, by the computing device, an indication of the information if the initial user-interaction metric is greater than or equal to the respective user-interaction metric of each of the plurality of future states; and if the initial user-interaction metric for the information is less than the respective user-interaction metric of each of the plurality of future states, refraining, by the computing device, from outputting the indication of the information.

Clause 2. The method of clause 1, further comprising: after refraining from outputting the indication of the information, and responsive to determining that a subsequent state of the user corresponds to a particular future state from the plurality of future states, outputting the indication of the information, wherein the respective user-interaction metric of the particular future state is greater than or equal to the respective user-interaction metric of each other future state from the plurality of future states.

Clause 3. The method of clause 2, wherein refraining from outputting the indication of the information includes outputting one or more other indications of other information while refraining from outputting the indication of the information and prior to determining that the subsequent state of the user corresponds to the particular future state.

Clause 4. The method of any of clauses 1-3, wherein the initial user-interaction metric is further determined based on at least one of a type of the information, a priority of the information, or content of the information.

Clause 5. The method of clause 4, further comprising: determining, based on at least one of a type of the information, a priority of the information, or content of the information, the respective user-interaction metric of each of the plurality of future states.

Clause 6. The method of any of clauses 1-5, further comprising: determining the initial state of the user and each of the plurality of future states of the user based on at least one of: past or current context of the user, past or current context of the computing device, or past or current context of other users and other computing devices.

Clause 7. The method of any of clauses 1-6, wherein the initial state of the user and each of the plurality of future states of the user each define at least one of a time of day, a location of the user, an action of the user, or a state of the computing device.

Clause 8. The method of any of clauses 1-7, wherein the indication of the information includes one or more of: a graphical notification, an audible notification, a haptic notification, or a voice notification.

Clause 9. The method of any of clauses 1-8, further comprising: receiving, by the computing device, from the machine-learning model, data indicative of whether the initial user-interaction metric for the information is greater than or equal to the respective user-interaction metric of each of the plurality of future states comprises, wherein determining whether the initial user-interaction metric for the information is greater than or equal to the respective user-interaction metric of each of the plurality of future states is determined based on the data.

Clause 10. The method of claim 9, wherein determining the initial state of the user and each of the plurality of future states of the user comprises determining the initial state of the user and each of the plurality of future states of the user using the machine-learning model and one or more of past or current context of the user, past or current context of the computing device, or past or current context of other users and other computing devices.

Clause 11. A computing device comprising: at least one processor; and a memory including instructions that, when executed, cause the at least one processor to: determine, based on an initial state of a user of the computing device, an initial user-interaction metric for information to be presented to the user; predict, using a machine-learning model, a plurality of future states of the user of the computing device, wherein each future state from the plurality of future states is associated with a respective user-interaction metric for the information; determine whether the initial user-interaction metric for the information is greater than or equal to the respective user-interaction metric of each of the plurality of future states; output an indication of the information if the initial user-interaction metric is greater than or equal to the future user-interaction metric of each of the plurality of future states; and if the initial user-interaction metric for the information is less than the future user-interaction metric of any of the plurality of future states, refrain from outputting the indication of the information.

Clause 12. The computing device of clause 11, wherein the memory further includes instructions that, when executed, cause the at least one processor to: after refraining from outputting the indication of the information, and responsive to determining that a subsequent state of the user corresponds to a particular future state from the plurality of future states, output the indication of the information, wherein the respective user-interaction metric of the particular future state is greater than or equal to the respective user-interaction metric of each other future state from the plurality of future states.

Clause 13. The computing device of clause 12, wherein the memory further includes instructions that, when executed, cause the at least one processor to refrain from outputting the indication of the information by at least outputting one or more other indications of other information while refraining from outputting the indication of the information and prior to determining that the subsequent state of the user corresponds to the particular future state.

Clause 14. The computing device of any of clauses 11-13, wherein the initial user-interaction metric is further determined based on at least one of a type of the information, a priority of the information, or content of the information.

Clause 15. The computing device of any of clauses 11-14, wherein the computing device comprises a server, a mobile computing device, a wearable device, an automotive or home infotainment device, or an assistant device.

Clause 16. A computer-readable storage medium comprising instructions that, when executed, cause at least one processor of a computing system to: determine, based on an initial state of a user of a computing device, an initial user-interaction metric for information to be presented to the user; predict, using a machine-learning model, a plurality of future states of the user of the computing device, wherein each future state from the plurality of future states is associated with a respective user-interaction metric for the information; determine whether the initial user-interaction metric for the information is greater than or equal to the respective user-interaction metric of each of the plurality of future states; output an indication of the information if the initial user-interaction metric is greater than or equal to the respective user-interaction metric of each of the plurality of future states; and if the initial user-interaction metric for the information is less than the respective user-interaction metric of any of the plurality of future states, refrain from outputting the indication of the information.

Clause 17. The computer-readable storage medium of clause 16, wherein the instructions, when executed, further cause the at least one processor to: after refraining from outputting the indication of the information, and responsive to determining that a subsequent state of the user corresponds to a particular future state from the plurality of future states, output the indication of the information, wherein the respective user-interaction metric of the particular future state is greater than or equal to the respective user-interaction metric of each other future state from the plurality of future states.

Clause 18. The computer-readable storage medium of clause 17, wherein the instructions, when executed, further cause the at least one processor to refrain from outputting the indication of the information by at least outputting one or more other indications of other information while refraining from outputting the indication of the information and prior to determining that the subsequent state of the user corresponds to the particular future state.

Clause 19. The computer-readable storage medium of any of clauses 16-18, wherein the instructions, when executed, further cause the at least one processor to determine the initial user-interaction metric is further based on at least one of a type of the information, a priority of the information, or content of the information.

Clause 20. The computer-readable storage medium of any of clauses 16-19, wherein the initial user-interaction metric and the respective user-interaction metric of each of the plurality of future states is a click-through-rate associated with the indication of the information.

Clause 21. A method comprising: receiving, by a computing device, a notification indicating information that is to be presented to a user of the computing device; determining, using a machine-learning model, based on user information and other information about other users of other computing devices, an initial state of the user and a future state of the user; determining, using the machine-learning model, an initial user-interaction metric for presenting the information indicated by the notification during the initial state of the user and a future user-interaction metric for presenting the information indicated by the notification during the future state of the user; if the initial user-interaction metric is greater than or equal to the future user-interaction metric, outputting, at a current time, an indication of the notification; and if the initial user-interaction metric is less than the future user-interaction metric, refraining from outputting the indication of the notification until a later time during which a subsequent state of the user corresponds to the future state.

Clause 22. The method of clause 21, further comprising: after refraining from outputting the indication of the notification until the later time, and responsive to determining that the subsequent state of the user corresponds to the future state, outputting the indication of the notification.

Clause 23. The method of any one of clauses 21-22, further comprising: while refraining from outputting the indication of the notification and prior to determining that the subsequent state of the user corresponds to the future state, outputting indications of one or more other notifications.

Clause 24. The method of any one of clauses 21-23, wherein determining the initial user-interaction metric and the future user-interaction metrics are determined using the machine-learning model and based on at least one of a type of the notification, a priority of the notification, or content of the information indicated by the notification.

Clause 25. The method of any one of clauses 21-24, wherein the initial user-interaction metric and the future user-interaction metric is a click-through-rate associated with the indication of the notification.

Clause 26. The computing device of clause 11, comprising means for performing any of the methods of clauses 1-10 or 21-25.

Clause 27. The computer-readable storage medium of clause 16, comprising further instructions that, when executed cause the at least one processor of the computing device of any of clauses 11-15 to perform any of the methods of clauses 1-10 or 21-25.

Clause 28. A system comprising means for performing any of the methods of clauses 1-10 or 21-25.

Clause 29. A computing system comprising means for performing any of the methods of clauses 1-10 or 21-25.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable medium may include computer-readable storage media or mediums, which corresponds to a tangible medium such as data storage media, or communication media including any medium that facilitates transfer of a computer program from one place to another, e.g., according to a communication protocol. In this manner, computer-readable medium generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various embodiments have been described. These and other embodiments are within the scope of the following claims.

What is claimed is:

1. A method comprising:
determining, based on an initial state of a user of a computing device, an initial user-interaction metric for information to be presented to the user;
predicting, using a machine-learning model, a plurality of future states of the user of the computing device, wherein each future state from the plurality of future states is associated with a respective user-interaction metric for the information that has been adjusted, by the machine-learning model, by a weighting factor for that particular future state;
determining whether the initial user-interaction metric for the information is greater than or equal to the respective user-interaction metric of each of the plurality of future states;
outputting, by the computing device, an indication of the information if the initial user-interaction metric is greater than or equal to the respective user-interaction metric of each of the plurality of future states; and
if the initial user-interaction metric for the information is less than the respective user-interaction metric of each of the plurality of future states, refraining, by the computing device, from outputting the indication of the information.

2. The method of claim 1, further comprising:
after refraining from outputting the indication of the information, and responsive to determining that a subsequent state of the user corresponds to a particular future state from the plurality of future states, outputting the indication of the information, wherein the respective user-interaction metric of the particular future state is greater than or equal to the respective user-interaction metric of each other future state from the plurality of future states.

3. The method of claim 2, wherein refraining from outputting the indication of the information includes outputting one or more other indications of other information while refraining from outputting the indication of the information and prior to determining that the subsequent state of the user corresponds to the particular future state.

4. The method of claim 1, wherein the initial user-interaction metric is further determined based on at least one of a type of the information, a priority of the information, or content of the information.

5. The method of claim 4, further comprising:
determining, based on at least one of a type of the information, a priority of the information, or content of the information, the respective user-interaction metric of each of the plurality of future states.

6. The method of claim 1, further comprising:
determining the initial state of the user and each of the plurality of future states of the user based on at least one of:
past or current context of the user,
past or current context of the computing device, or
past or current context of other users and other computing devices.

7. The method of claim 1, wherein the initial state of the user and each of the plurality of future states of the user each define at least one of a time of day, a location of the user, an action of the user, or a state of the computing device.

8. The method of claim 1, wherein the indication of the information includes one or more of: a graphical notification, an audible notification, a haptic notification, or a voice notification.

9. The method of claim 1, further comprising:
receiving, by the computing device, from the machine-learning model, data indicative of whether the initial user-interaction metric for the information is greater than or equal to the respective user-interaction metric of each of the plurality of future states comprises, wherein determining whether the initial user-interaction metric for the information is greater than or equal to the respective user-interaction metric of each of the plurality of future states is determined based on the data.

10. The method of claim 9, wherein determining the initial state of the user and each of the plurality of future states of the user comprises determining the initial state of the user and each of the plurality of future states of the user using the machine-learning model and one or more of past or current context of the user, past or current context of the computing device, or past or current context of other users and other computing devices.

11. A computing device comprising:
at least one processor; and
a memory including instructions that, when executed, cause the at least one processor to:
determine, based on an initial state of a user of the computing device, an initial user-interaction metric for information to be presented to the user;
predict, using a machine-learning model, a plurality of future states of the user of the computing device, wherein each future state from the plurality of future states is associated with a respective user-interaction metric for the information that has been adjusted, by the machine-learning model, by a weighting factor for that particular future state;
determine whether the initial user-interaction metric for the information is greater than or equal to the respective user-interaction metric of each of the plurality of future states;
output an indication of the information if the initial user-interaction metric is greater than or equal to the future user-interaction metric of each of the plurality of future states; and
if the initial user-interaction metric for the information is less than the future user-interaction metric of any of the plurality of future states, refrain from outputting the indication of the information.

12. The computing device of claim 11, wherein the memory further includes instructions that, when executed, cause the at least one processor to:
after refraining from outputting the indication of the information, and responsive to determining that a subsequent state of the user corresponds to a particular future state from the plurality of future states, output the indication of the information, wherein the respective user-interaction metric of the particular future state is greater than or equal to the respective user-interaction metric of each other future state from the plurality of future states.

13. The computing device of claim 12, wherein the memory further includes instructions that, when executed, cause the at least one processor to refrain from outputting the indication of the information by at least outputting one or more other indications of other information while refraining from outputting the indication of the information and prior to determining that the subsequent state of the user corresponds to the particular future state.

14. The computing device of claim 11, wherein the initial user-interaction metric is further determined based on at least one of a type of the information, a priority of the information, or content of the information.

15. The computing device of claim 11, wherein the computing device comprises a server, a mobile computing device, a wearable device, an automotive or home infotainment device, or an assistant device.

16. A method comprising:
receiving, by a computing device, a notification indicating information that is to be presented to a user of the computing device;
determining, using a machine-learning model, based on user information and other information about other users of other computing devices, an initial state of the user and a future state of the user;
determining, using the machine-learning model, an initial user-interaction metric for presenting the information indicated by the notification during the initial state of the user and a future user-interaction metric for presenting the information indicated by the notification during the future state of the user, the future user-interaction metric having been adjusted, by the machine-learning model, by a weighting factor for the future state;
if the initial user-interaction metric is greater than or equal to the future user-interaction metric, outputting, at a current time, an indication of the notification; and
if the initial user-interaction metric is less than the future user-interaction metric, refraining from outputting the indication of the notification until a later time during which a subsequent state of the user corresponds to the future state.

17. The method of claim 16, further comprising:
after refraining from outputting the indication of the notification until the later time, and responsive to determining that the subsequent state of the user corresponds to the future state, outputting the indication of the notification.

18. The method of claim 16, further comprising:
while refraining from outputting the indication of the notification and prior to determining that the subsequent state of the user corresponds to the future state, outputting indications of one or more other notifications.

19. The method of claim 16, wherein determining the initial user-interaction metric and the future user-interaction metrics are determined using the machine-learning model and based on at least one of a type of the notification, a priority of the notification, or content of the information indicated by the notification.

20. The method of claim 16, wherein the initial user-interaction metric and the future user-interaction metric is a click-through-rate associated with the indication of the notification.
